(19) United States
(12) Patent Application Publication
(10) Pub. No.: US 2022/0058725 A1
(43) Pub. Date: Feb. 24, 2022

(54) METHODS AND SYSTEMS FOR PRODUCT ORDER FULFILLMENT, PROCESSING, AND MANAGEMENT WITH REUSABLE PRODUCT AND SHIPPING CONTAINERS

(71) Applicant: Planet Positive Packaging PBC, LLC, New York, NY (US)

(72) Inventors: David William Knowlton, Westerly, RI (US); Petra Nemcova, Miami Beach, FL (US); Stephanie Stahl, New York, NY (US)

(21) Appl. No.: 17/405,251

(22) Filed: Aug. 18, 2021

Related U.S. Application Data
(60) Provisional application No. 63/068,596, filed on Aug. 21, 2020.

(51) Int. Cl. G06Q 30/06; G06Q 10/08

(52) U.S. Cl. CPC G06Q 30/0645; G06Q 10/0837; G06Q 10/0832; G06Q 10/087

(57) ABSTRACT

Systems and methods for fulfilling an order for a product placed by a customer in which the product is stored and transported within reusable containers. A method includes receiving from a customer an order for an amount of a product; selecting a primary container for holding the amount of the product; selecting a shipping container for holding the selected primary container; charging a product fee to an account, the product fee based on the amount of product ordered; determining a container rental fee based on the selected primary container and the selected shipping container; placing a hold on the account for an amount equal to the container rental fee; filling the selected primary container with the amount of the product from a bulk supply of the product; placing the filled selected primary container in the selected shipping container; and shipping the selected shipping container to the customer.

### CROSS-REFERENCE TO RELATED APPLICATIONS

This application claims priority to, and the benefit of, U.S. Provisional Patent Application No. 63/068,596, filed Aug. 21, 2020, which is hereby incorporated herein by reference for all that it discloses.

### TECHNICAL FIELD

The present invention relates, generally, to systems and methods for fulfilling customer product orders, and, more specifically, to systems and methods for fulfilling customer product orders with reusable product and shipping containers.

### BACKGROUND

As consumers seek more convenience and less contact with other individuals in the age of social distancing and pandemic response, e-commerce has flourished, including online buying for goods previously purchased in person at brick-and-mortar stores. The convenience of online shopping and home delivery of goods continues to grow over time in popularity and demand. In particular, personal care products are now part of this growing trend whereby consumers are having products, such as nutritional supplements, hair products, and cosmetic products, being delivered directly to the customer's home. However, existing systems which provide such services are not without their drawbacks.

Although personal care products are produced in bulk, at the consumer level, personal care products are generally purchased in packaging comprising relatively small individual containers, each of individual size, shape, construction and materials, including single-use plastics. These many and varied containers can create a very disorderly, messy household appearance when in use. More importantly, as single-use packaging, these containers also create environmental problems and often cannot be recycled. For an individual consumer, this problem is not solved by buying bulk products in larger containers. For example, many personal care products, like cosmetics, are not suited for larger containers because they are used small quantities and, therefore, would expire long before the entire quantity of product could be used. Additionally, such bulk product containers which, for example, have been previously used by gyms and hotels for shampoos, conditioners, and lotions to eliminate single-use containers, cannot safely be used because it involves the sharing of personal use products. Furthermore, current recycling efforts have not solved the above problem because, given the nature of many products and bulk product containers, the containers cannot be cleaned sufficiently to be accepted by recycling facilities. In addition, many containers are often too small and/or are made of multiple materials, making them difficult or impossible to recycle.

Further to the above, such containers typically have to be shipped from different suppliers in multiple packages which are usually made out of cardboard or paper and filled with packing material, leading to further waste. Even when such containers come from a single online reseller, for example, the shipping containers are not consistently combined into a single package and, in any event, the shipping containers are generally made of paper or cardboard and filled with packing material which often cannot be recycled. Therefore, there exists a need for packaging and shipping containers which are able to be thoroughly cleaned, are reusable, and, at the end of their lifecycle, are recyclable. Furthermore, there exists a need for systems and methods which can provide reusable packaging to a consumer, as well as manage and track reusable packaging between a provider and a consumer.

### SUMMARY OF THE INVENTION

According to some embodiments, a method of fulfilling an order for a product placed by a customer comprises: receiving from the customer an order for a defined amount of the product; selecting a primary container, the primary container being adapted to hold the defined amount of the product; selecting a shipping container, the shipping container being adapted to hold the selected primary container; determining a shipping cost for shipping the shipping container to a location provided by the customer; charging a product and shipping fee to an account associated with the customer, the product and shipping fee based at least on the amount of defined product ordered and the shipping cost; determining a container rental fee based at least on the selected primary container and the selected shipping container; placing a hold on the account associated with the customer for an amount equal to the container rental fee; filling the selected primary container with the defined amount of the product from a bulk supply of the product; placing the filled selected primary container in the selected shipping container; and shipping the selected shipping container to the location identified by the customer.

In accordance with some embodiments, an order fulfillment system comprises: a plurality of primary containers configured to contain a product therein, wherein each of the primary containers comprises a corresponding primary container code and wherein each primary container code comprises identifying information about a corresponding one of the primary containers; a plurality of shipping containers for storing the primary containers during transport thereof, wherein each of the shipping containers comprises a corresponding shipping container code and wherein each shipping container code comprises identifying information about a corresponding one of the shipping containers; an operational control system comprising (i) a server comprising a memory having a database and (ii) at least one mobile device operatively connected to the server and configured to detect the primary container code and the shipping container code, wherein the operational control system is configured to: create and update an electronic record, in the database, of each of the primary containers, wherein the electronic record comprises information associated with the primary container code; create and update an electronic record, in the database, of each of the shipping containers, wherein the electronic record comprises information associated with the shipping container code; receive an order for a product and create an electronic record, in the database, of the order; determine a size and a quantity of the primary containers, wherein the size and the quantity of the primary containers are determined based on the electronic record of the order; determine a size and a quantity of the shipping containers, wherein the size and the quantity of the shipping containers are determined based on the size and the quantity of the primary containers; process the order, the order comprising a purchase of the product, a rental of the quantity of the primary containers, and a rental of the quantity of the shipping containers; update the electronic record of the order to associate the electronic record of the order with a first one of the primary containers and a first one of the shipping containers, wherein the first one of the primary containers contains the product; provide instructions to place the first one of the primary containers in the first one of the shipping containers; and provide instructions to ship the first one of the shipping containers.

In accordance with some embodiments, a method for managing and tracking reusable containers comprises the steps of: receiving a plurality of unused containers; permanently affixing a container code to each of the unused containers, wherein each container code comprises identifying information about a corresponding one of the unused containers; creating a record of each of the unused containers, wherein each container code is associated with a corresponding record; preparing the unused containers, comprising sanitizing the unused containers; updating the record of at least one of the unused containers to associate the at least one of the unused containers with a first order; updating a record of at least one of a plurality of used containers to associate the at least one of the used containers with the first order, wherein each of the used containers comprises a container code comprising identifying information about a corresponding one of the used containers; coordinating a shipment of the at least one of the unused containers to a recipient; receiving from the recipient the at least one of the used containers; and updating the record of the at least one of the used containers.

In accordance with some embodiments, a method for managing and tracking reusable containers comprises the steps of: receiving a plurality of unused primary containers and a plurality of unused shipping containers; permanently affixing a primary container code to each of the unused primary containers, wherein each primary container code comprises identifying information about a corresponding one of the unused primary containers; permanently affixing a shipping container code to each of the unused shipping containers, wherein each shipping container code comprises identifying information about a corresponding one of the unused shipping containers; creating a record of each of the unused primary containers, wherein each primary container code is associated with a corresponding record; creating a record of each of the unused shipping containers, wherein each shipping container code is associated with a corresponding record; sanitizing the unused primary containers and the unused shipping containers; organizing the unused primary containers into at least one batch; assigning a container batch code to the at least one batch, wherein the container batch code comprises identifying information about the at least one batch; updating the record of each of the unused primary containers to associate each of the unused primary containers with the at least one batch; filling each of the unused primary containers with a product, wherein the product is determined by the container batch code; updating the record of each of the unused primary containers; updating the record of a first one of the unused primary containers to associate the first one of the unused primary containers with an order; updating the record of a first one of the unused shipping containers to associate the first one of the unused shipping containers with the order; updating a record of a used primary container to associate the used primary container with the order, wherein the used primary container comprises a primary container code comprising identifying information about the used primary container; coordinating a shipment of the first one of the unused primary containers and the first one of the unused shipping containers to a recipient, wherein the first one of the unused primary containers is stored within the first one of the unused shipping containers; receiving, from the recipient, the used primary container and a used shipping container, wherein the used shipping container comprises the first one of the unused shipping containers; and updating the record of the used primary container and the record of the used shipping container to dissociate the used primary container and the used shipping container with the order.

In accordance with some embodiments, a method for managing payment authorization holds using a payment processing system comprising a server operatively connected to a network, wherein the server is configured to facilitate payment card transactions, comprises the steps of: placing a first hold on a payment card associated with an order, wherein the order initially comprises a first status; initiating a first hold time, wherein the first hold expires after the first hold time; periodically checking a status of the order and, if the order comprises the first status, maintaining the first hold; after the expiration of the first hold time, removing the first hold and initiating a first wait time; scheduling the placement of a second hold on the payment card after the expiration of the first wait time; periodically checking a status of the order during the first wait time and, if the order comprises a second status, cancelling the scheduled placement of the second hold; and after the expiration of the first wait time and if the order comprises the first status, placing one or more subsequent holds on the payment card and initiating one or more subsequent hold times.

In accordance with some embodiments, a method for managing the rental of a container using an operational control system comprising a payment processing system comprising a server operatively connected to a network, wherein the server is configured to facilitate payment card transactions, comprises the steps of: receiving an order, wherein the order comprises a purchase of a product and a rental of a container for containing the product; charging a payment card for the purchase of the product; placing a first hold on the payment card for the container; initiating a first hold time, wherein the first hold expires after the first hold time; coordinating a shipment of the product and the container from a warehouse to a customer; periodically checking a status of return of the container by the warehouse from the customer during the first hold time and, if the container is not returned, maintaining the first hold; after the expiration of the first hold time, removing the first hold and initiating a first wait time; scheduling the placement of a second hold on the payment card; periodically checking a status of receipt of the container by the warehouse from the customer during the first wait time; after the expiration of the first wait time and if the container is not returned, placing the second hold on the payment card; initiating a second hold time, wherein the second hold expires after the second hold time; and periodically checking a status of return of the container by the warehouse from the customer during the second hold time and, if the container is not received, maintaining the second hold.

In accordance with some embodiments, a method comprises: receiving a primary container and a shipping container; permanently affixing a primary container code to the primary container, wherein the primary container code comprises identifying information about the primary container; permanently affixing a shipping container code to the shipping container, wherein the shipping container code comprises identifying information about the shipping container; creating a record of the primary container, wherein the primary container code is associated with the record; creating a record of the shipping container, wherein the shipping container code is associated with the record; sanitizing the primary container and the shipping container; filling the primary container with a product; receiving an order and creating a record of the order, wherein the order comprises a request to purchase the product and a rent the primary container and the shipping container; determining a size of the primary container, wherein the size of the primary container is determined based on the record of the order; determine a size of the shipping container, wherein the size of the shipping container is determined based on the size of the primary container; updating the record of the primary container to associate the primary container with the order; updating the record of the shipping container to associate the shipping container with the order; updating a record of a used primary container to associate the used primary container with the order, wherein the used primary container comprises a primary container code comprising identifying information about the used primary container; charging a payment card for the purchase of the product; placing a hold on the payment card for the rental of the primary container and the shipping container, wherein the hold is set to expire after a hold time; coordinating a shipment of the primary container and the shipping container from a warehouse to a recipient, wherein the primary container is stored within the shipping container; periodically checking a status of return of the shipping container and the used primary container by the warehouse from the recipient during the hold time; receiving, from the recipient, the used primary container and the shipping container; updating the record of the used primary container and the record of the shipping container to dissociate the used primary container and the shipping container with the order; and cancelling the hold on the payment card.

### BRIEF DESCRIPTION OF THE DRAWINGS

FIG. 1 is a diagram illustrating an exemplary order fulfillment system in accordance with some embodiments of the present invention.

FIG. 2 is a perspective view illustrating an exemplary shipping container, shown in a closed position, in accordance with some embodiments of the present invention.

FIG. 3 is a perspective view illustrating the shipping container of FIG. 2 shown in an open position.

FIG. 4 is a flowchart illustrating an exemplary process flow for the recyclable use of primary containers and shipping containers, in accordance with some embodiments of the present invention.

FIG. 5 is a flowchart illustrating an exemplary process for managing payment card holds, in accordance with some embodiments of the present invention.

FIG. 6 is a flowchart illustrating an exemplary order and payment card processing method, in accordance with some embodiments of the present invention.

### DETAILED DESCRIPTION OF THE PREFERRED EMBODIMENTS

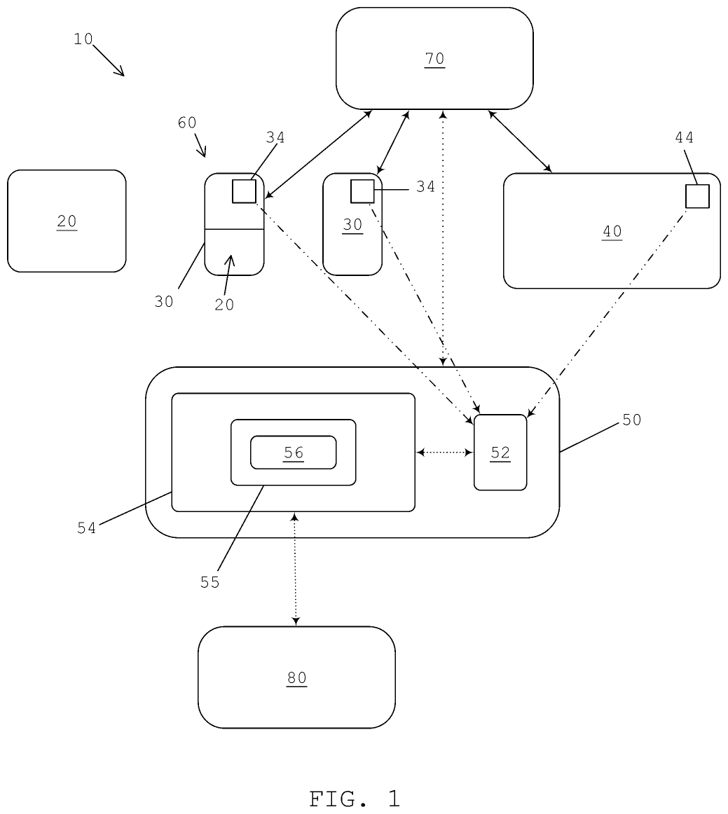

Referring, generally, to FIG. 1, an exemplary order fulfillment system 10 is illustrated in accordance with some embodiments of the present invention. Order fulfillment system 10 may comprise a plurality of reusable containers—primary containers 30 and shipping containers 40—and an operational control system 50. In some embodiments, order fulfillment system 10 may also comprise a cleaning or sanitization system 70 for cleaning and sanitizing primary containers 30 and shipping containers 40.

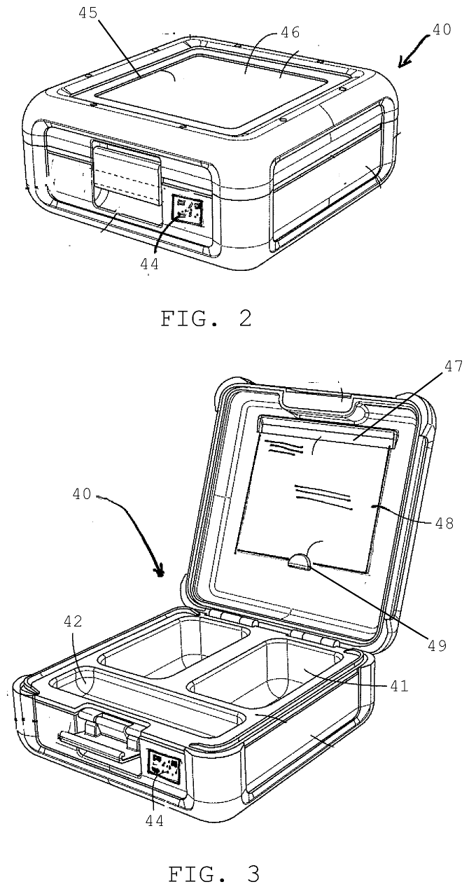

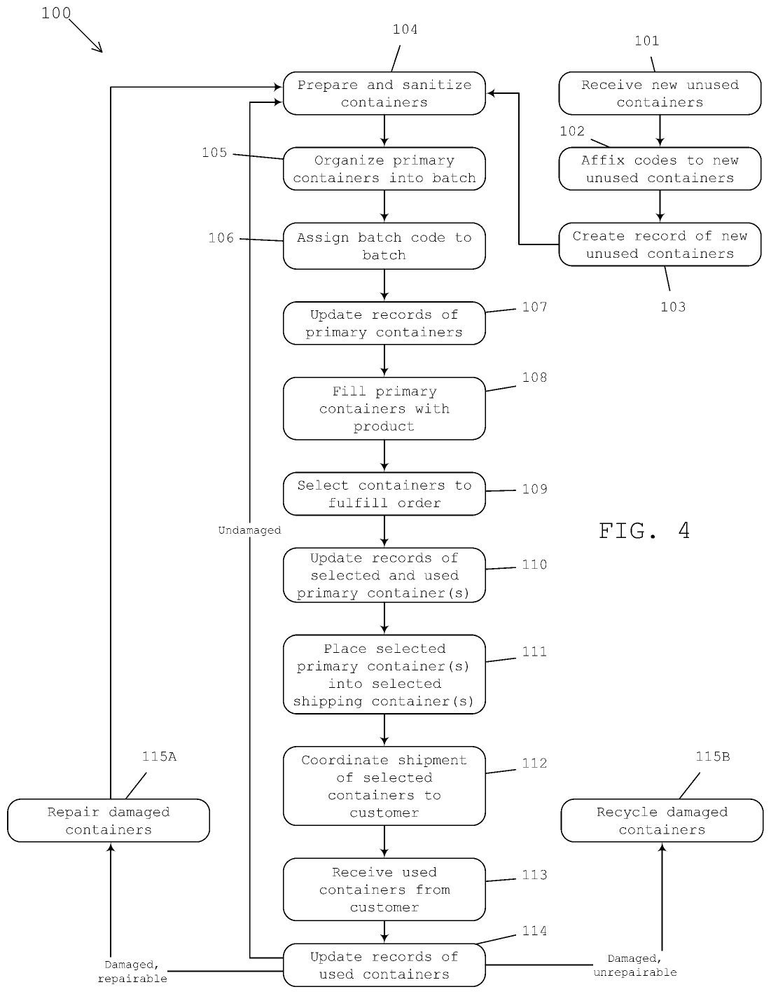

Referring now particularly to FIGS. 2 and 3, shipping container 40 may generally comprise a case having a hingedly engaged top. Shipping container 40 may be constructed from one or more rigid, durable materials, such as, but not limited to, aluminum or plastic. An interior portion of shipping container 40 may comprise a combination of large slot(s) 41 and/or small slot(s) (shown in FIG. 3) which may be configured to receive primary containers 30 of various sizes. Shipping container 40 may comprise a transparent, or semi-transparent, label window 45 and a transparent, or semi-transparent, cover 46 that can allow a label (which may be secured by a label insertion slot 47 and a label retention notch 49) to be seen on the exterior of shipping container 40. Exemplary embodiments of shipping container 40 are disclosed in U.S. Patent Application Publication No. US 2020/0317392 Ser. No. 16/843,352, published on Oct. 8, 2020, which is hereby incorporated herein by reference for all that it discloses.

According to some embodiments, an outbound (or shipping) label and return (or inbound) label may be provided as a single, combined label (e.g., label 48) which, for example, may be double-sided and/or foldable. However, the present invention should not be viewed as being limited in this respect. An outbound label (e.g., as a portion of combined label 48) may reflect the name of the shipping container 40, as well as a customer's name, and the number of trips taken by the shipping container 40 (e.g., ‘seahorse’ shipping container, trip no. 001) and may be inserted between label insertion slot 44 and label retention notch 46 on the inside of the shipping container 40. The return label (e.g., as a portion of combined label 48) may be placed on top of the ordered products inside the shipping container 40. To return the shipping container 40, the customer may either flip the combined outbound and return label 48, e.g., to show the return label on the outside of the shipping container, or swap the outbound label with the return label. The customer may then place outbound label in the shipping container 40 (e.g., for recycling/reuse purposes), along with any empty primary containers 30 from a prior order, and then return the shipping container 40. If the customer loses the return label (or combined outbound and return label 48), the customer can reprint it (e.g., from the customer's order history accessible via a website or mobile application).

Shipping container 40 may be provided with one or more machine-readable codes which can be associated with an electronic record, such as, but not limited to, a quick response (“QR”) code, barcode, or the like. For example, and as further illustrated in FIGS. 1 and 2, shipping container 40 may comprise a shipping container code 44 which may be engaged to, or otherwise associated with shipping container 40. In some embodiments, shipping container code 44 may be permanently affixed to shipping container 40 by a laser engraving or etching process in which the shipping container code 44 is engraved or etched into a portion (e.g., the lid) of shipping container 40. Alternatively other marking processes, such as stamping or the application of permanent inks or paints, may be used as well. A unique, permanent name (such as ‘seahorse’, referenced above) may also be assigned to each shipping container 40. Shipping container code 44 may include and/or be linked or correlated with certain identifying information associated with the corresponding shipping container 40. Such identifying information may include, for example, the name assigned to the shipping container 40, the number of trips taken by the shipping container 40, the size of the shipping container 40, the condition of the shipping container 40 (e.g., new, used, sanitized, damaged, etc.), any orders associated with the shipping container 40, etc.

Referring to FIG. 1, primary containers 30 may be configured to contain a defined amount of product 20. As will be explained in further detail herein, the defined amount of product 20 may be provided from a bulk supply of the product. According to some embodiments, the defined amount of product 20 (e.g., provided from the corresponding bulk supply of the product) may comprise personal care products, such as, but not limited to, lotions, oils, powders, cosmetics, serums, nutritional supplements (in both powder and capsule form), vitamins, gummies, and hair care products (e.g., shampoo, conditioner, masques, moisturizers, serums for hair, etc.), or other similar products for personal care or personal health. Alternatively, other types of products may be used. Primary containers 30 may comprise multiple sizes and/or configurations suitable for the particular product involved. For example, and according to some embodiments, primary containers 30 may comprise six configurations having volumes ranging from about 7 ml to about 200 ml. For instance, a first configuration may comprise a jar having a volume of about 200 ml; a second configuration may comprise a jar having a volume of about 150 ml; a third configuration may comprise a jar having a volume of about 100 ml; a fourth configuration may comprise a jar having a volume of about 50 ml; a fifth configuration may comprise a serum bottle having a volume of about 30 ml; and a sixth configuration may comprise a jar having a volume of about 7 ml.

Primary containers 30 may be configured to withstand multiple, preferably hundreds, of reuse cycles involving transit between a shipping warehouse and a customer. In some embodiments, primary container 30 may be in the form of a jar or a bottle, or the like. For example, and without limitation, a primary container may be a dropper bottle having a pipette, a bulb, and a wiper. It is to be appreciated, however, that a primary container 30 may be any container which may be suitable for repeated cleaning and sanitization and which may be configured to be stored within a shipping container 40.

In some embodiments of the present invention, primary containers 30 may comprise stainless steel or natural rubber; however, it is to be appreciated that other suitable materials, such as, but not limited to, glass, wood, and some plastics, can also be used provided that they can be sanitized appropriately in accordance with the teachings of the present invention. Although specific materials, sizes, and shapes have are described herein for embodiments of the present invention, the invention should not be viewed as being limited in this respect since other materials, sizes, and shapes could also be used as would be apparent to one of ordinary skill in the art after becoming familiar with the teachings of the present invention.

Similar to shipping container 40, according to some embodiments, primary container 30 may comprise one or more machine-readable codes which can be associated with an electronic record, such as, but not limited to, a QR code, barcode, or the like. For example, and as further illustrated in FIG. 1, primary container 30 may comprise a primary container code 34 which may be engaged to or otherwise associated with primary container 30. In some embodiments, primary container code 34 may be permanently affixed to primary container 30 by a laser etching or engraving process in which the primary container code 34 is engraved or etched into a portion (e.g., the outer surface) of primary container 30. Alternatively, other marking processes, such as stamping or the application of permanent inks or paints, may be used as well. Primary container code 34 may comprise and/or be correlated with identifying information associated with a corresponding primary container 30. Such identifying information may include, for example, the number of trips or cycles taken by the primary container 30, the size and/or type (configuration) of the primary container 30, the condition of the primary container 30 (e.g., new, used, sanitized, damaged, etc.), any orders associated with the primary container 30, etc.

Operational control system 50 may generally include a server 54 and at least one mobile device 52 operatively connected to server 54 (as indicated by the two-way dotted line between mobile device 52 and server 54). Server 54 may comprise a memory 55 having a database 56 configured to store electronic data and, as further illustrated in FIG. 1, server 54 may be operatively connected to a network 80 (as indicated by the two-way dotted line between server 54 and network 80). Mobile device 52 may be configured to detect, scan, and/or capture, (e.g., using a camera of mobile device 52) a machine-readable code, such as primary container code 34 and shipping container code 44 (as indicated by the dashed lines extending from primary container code 34 and shipping container code 44. It should be appreciated that mobile device 52 may include any device capable of detecting, scanning, and/or capturing, a machine-readable code, such as, but not limited to, a smartphone, a tablet, a smartwatch, or the like, and which is equipped with a central processing container (“CPU”), a mobile operating system, and one or more software applications and is connected to a network. In some embodiments, operational control system 50 may further comprise one or more CPUs, in addition to mobile device 52.

Operational control system 50 generally may comprise a group of subsystems which manage, track, and process customer orders, as well as manage and track primary containers and shipping containers throughout their lifecycles and reuse cycles. Electronic information (e.g., records) associated with customer orders, primary containers 30, and shipping containers 40 may be initially entered into operational control system 50 either manually (e.g., by keying data) or automatically (e.g., by scanning one or more codes), or a combination thereof. This electronic information can be accessed (and updated) via any of the subsystems of operational control system 50. In some embodiments, operational control system 50 may comprise one or more CPUs (including mobile device 52), memory devices, storage devices, network connections, and communications links. In one embodiment, communications links may be wireless, although wired connections, or a combination of wireless and wired connections, could also be used. Specific algorithms for various subsystems of operation control system 50 may be incorporated into a non-transitory, computer-readable set of instructions embedded in software or firmware to carry out one or more steps of one or more methods of the present invention, rendering the computers of operational control system 50 special purpose computers. The term “non-transitory”, as used herein, is a limitation of the medium itself (i.e., tangible, not a signal) as opposed to a limitation on data storage persistency (e.g., RAM vs. ROM).

In accordance with some embodiments, operational control system 50 may be configured to: (i) create and update electronic records, in database 56, of primary containers 30 and shipping containers 40, wherein each electronic record comprises information associated with a corresponding primary container code 34 or shipping container code 44; (ii) receive an order for a defined amount of product 20 and create an electronic record thereof in database 56; (iii) determine or select a size, type, and/or quantity of primary container(s) 30 based on the order record (e.g., the defined amount of product 20); (iv) determine or select a size and a quantity of shipping container(s) 40 based on the size, type, and quantity of selected primary containers 30; (v) process the order, wherein the order comprises a purchase of a defined amount of the product 20; (vi) determine a rental fee based at least on the selected primary container 30 and the selected shipping container 40; (vii) update the order record to associate the record with a first one of primary containers 30 and with a first one of shipping containers 40, wherein the first one of primary containers 30 contains the ordered product (in the form of finished product 60, comprising primary container 30 filled with the defined amount of product 20 from the bulk supply of the product), as illustrated in FIG. 1); (viii) provide instructions to place the first one of primary containers 30 in the first one of shipping containers 40; and (ix) provide instructions to ship the first one of shipping containers 40 (containing finished product 60).

In some embodiments, operational control system 50 may be further configured to provide instructions to the customer to return the first one of shipping containers 40 (as well as any used primary containers 30). Operational control system 50 may also be configured to update the electronic record of the first one of shipping containers 40 to dissociate the shipping container with the order. Similarly, operational control system 50 may also be configured to update the electronic record of the first one the shipping containers to provide a status of the shipping container (e.g., damaged and repairable, damaged and not repairable). Furthermore, operational control system 50 may be configured to process payment card transactions. More particularly, server 54 may be configured to facilitate payment card transactions.

According to some embodiments, operational control system 50 may further include one or more monitoring devices (e.g., a webcam), a customer ordering system, a warehouse management system, a credit card processing system, and an administrative system. The customer ordering system, warehouse management system, credit card processing system, and administrative system, as well as other aspects of operational control system 50, may have fully integrated functionalities.

According to some embodiments of the present invention, the customer ordering system may be configured to allow a customer to: (i) order finished product(s) 60; (ii) receive one or more unused primary containers 30 and one or more unused shipping containers 40; (iii) pay for finished product(s) 60, shipping fees, and rental fees for unused primary containers 30 and unused shipping container 40, as well as any other applicable fees (using the payment card processing system); and (iv) arrange for the delivery of finished product(s) 60, as well as the return of used primary containers 30 in a used shipping container 40. In addition, in some embodiments, the customer ordering system may be fully integrated with ordering and tracking system (not shown) associated with a parcel delivery service or company (e.g., a website) and simulator in order to accurately calculate shipping costs and delivery timing in order to charge the customer at the time of purchase.

In accordance with some embodiments, the warehouse management system may be configured to electronically manage and track the defined amount of product(s) 20 (e.g., to be filled from the bulk supply of the product), finished product(s) 60, primary container(s) 30, and shipping container(s) 40 throughout the storage, fulfillment, shipment, sanitization, and replacement cycles, through the scanning of various codes (e.g., shipping container codes 44, shipping container batch codes, primary container codes 34, primary container batch codes, etc.) using mobile device 52. Operations managed through the warehouse management system may comprise managing inventory of primary containers 30 and shipping containers 40 and their corresponding status (e.g., ready for use, undergoing repair, undergoing sanitization, in custody of a customer, etc.), storage of bulk product 20, customer order fulfillment and shipping, return of primary containers 30 and shipping containers 40 (e.g., from a customer), sanitization of primary containers 30 and shipping containers 40, and management of finished products 60 and their status (e.g., in inventory, shipped, returned, etc.).

According to some embodiments, the administrative system may be configured to support management oversight of operational control system 50 (and the processes thereof), billing, and customer management, including, for example, automatically coordinating email and/or text message reminders to customers about return deadlines for used primary containers in the custody of the customer.

In accordance with some embodiments of the present invention, the payment processing system may be configured to charge customers for defined amount of product 20 purchased (e.g., as filled from a bulk supply of the product) as part of finished products 60, while also establishing a system of security deposit transactions (referred to hereinafter as “holds”) placed as collateral for primary containers 30 and shipping containers 40 while they are in the custody of a customer prior to being returned. The payment processing system of the present invention may be operationally associated, or integrated, with a web-based, third-party electronic payment processing system that interfaces with the customer ordering system. According to some embodiments, the payment processing system may be configured to create a specific routine implemented in software that automatically renews a hold, or multiple holds, for primary containers 30 and shipping containers 40, while the containers 30, 40 are in the custody of the customer, without having overlapping holds (explained in further detail hereafter). In some embodiments, the hold or holds may be for an amount equal to determined container rental fee (e.g., for the selected primary container 30 and/or shipping container 40).

In some embodiments, the payment processing system may be configured to place a series of subsequent holds which may be placed for increasingly longer periods of time. Furthermore, the credit card processing system may be configured to (i) automatically charge a payment card (e.g., credit card) after a given period of time for returning primary containers 30 and shipping containers 40 has expired, or if primary containers 30 and/or shipping containers 40 are damaged upon return, and (ii) automatically cancel a corresponding hold when primary containers 30 and/or shipping containers 40 have been returned undamaged and on time and their receipt is recorded within warehouse management system (e.g., primary container code 34 and shipping container code 44 have been scanned into the system and recorded as returned and undamaged).

The subsystems of operational control system 50 described heretofore and throughout may comprise application software specific to each particular subsystem which may be downloaded and stored on mobile device 52, or other CPU. Each application, when executed by mobile device 52, may be configured to provide a user interface for providing information to, and receiving information from, operational control system 50, which may then be accessed or shown on a display. The user interface may provide the user with different selection options depending on the functionality of an associated subsystem.

According to some embodiments, and with further reference to FIG. 1, order fulfillment system 10 may further include a cleaning or sanitization system 70. Cleaning or sanitization system 70 may generally comprise a clean room, a commercial washing container, and a commercial drying container for cleaning and/or sanitizing shipping containers 40 and primary containers 30, including their various component parts. In some embodiments, cleaning or sanitization system 70 may also comprise a plurality of cleaning trays configured to receive shipping containers 40 and primary containers 30, as well as their various component parts. According to some embodiments, components of sanitization system 70 may be operatively connected to operational control system 50 (as indicated by the two-way dotted arrow between sanitization system 70 and operational control system 50) for controlling and monitoring the operation of sanitization system 70. Primary containers 30 and shipping containers 40 may be cleaned and sanitized by sanitization system 70 prior to entering the fulfillment process and after they are returned from the customer. However, if any primary containers 30 or shipping containers 40 become contaminated at any time, they may be returned to sanitization system 70.

Various process and methods are described below with reference to exemplary steps for carrying out such processes and methods. Although the steps may be presented in a given order, it is to be appreciated that, in some embodiments, the order of such steps may be altered without changing the scope of the process or method described. Similarly, although two or more steps may be described as being performed successively, it is to be appreciated that, in some embodiments, such steps may be performed simultaneously without changing the scope of the process or method described.

It is also to be appreciated that the terms “associate” and “dissociate”, as used throughout, may generalize any methods or processes by which electronic data may be linked or unlinked, respectively. Such linking or unlinking of data may be achieved by providing instructions accordingly within operational control system 50 which may be manually provided (at least in part), for example, by keying data, or which may be automatically provided, for example, by scanning a container or batch code.

Referring generally now to FIG. 4, an exemplary process flow 100 for the recyclable use of primary containers 30 and shipping containers 40 is illustrated. Process flow 100 may comprise Steps 101-115B, which may generalize various processes involving intake, preparation, order fulfillment, and shipment of primary containers 30 and shipping containers 40.

Beginning with Step 101, new unused primary containers 30 and new unused shipping containers 40 (received, for example, from a manufacturer) may be received for entering into inventory. Before any new unused containers 30, 40 can be entered into inventory, and in accordance with Step 102, the new unused containers 30, 40 may each be assigned a unique, permanent container code (e.g., a QR code) which, according to some embodiments, may be affixed to each container 30, 40 and comprises identifying information about the corresponding container 30, 40. At this point, new unused containers 30, 40 may also be inspected for quality prior to being assigned a container code. Following Step 102, and with reference to Step 103, a record of each container 30, 40 may be created and each container code (e.g., primary container code 34 for a corresponding primary container 30 and a shipping container code 44 for a corresponding shipping container 40) may be associated with a corresponding record. Once the unused containers 30, 40 have been entered into inventory, the containers 30, 40 are ready to be introduced into a cycle involving the continuous reuse/recycling of the containers 30, 40. At this point, the unused containers 30, 40 can be continuously managed and tracked throughout their entire lifecycle (via, e.g., operational control system 50).

In Step 104, primary containers 30 and shipping containers 40 are prepared for order fulfillment. At this point, both unused containers 30, 40 as well as previously-used containers 30, 40 (i.e., containers 30, 40 which have been used in the fulfillment of at least one order and have since been returned) are cleaned and sanitized. According to some embodiments, shipping container codes 44 and primary container codes 34 may be scanned when the shipping containers 40 and (empty) primary containers 30, respectively, arrive at the warehouse and are then sent to the clean room of the sanitization system. In some embodiments, the containers 30, 40 may be disassembled into their component parts prior to cleaning and sanitizing. Shipping containers 40 and primary containers 30 may be cleaned and dried in the washing and drying units. Primary containers 30 (or the components thereof) may be cleaned and dried in the washing and drying unit using specially designed trays configured for such purpose. Each component of a container 30, 40 (e.g., cap, cap insert, body, label cuff, dropper, bulb, wiper, etc.) may be cleaned and sanitized separately. Thereafter, the cleaned and sanitized containers 30, 40 may be inspected and/or tested, separately or in combination, reassembled (if needed) and closed. Sanitized shipping containers 40 are sent from the clean room to a location or station for order fulfillment. Sanitized primary containers 30 are sent from the clean room to a location or station for filling with the defined amount of product 20 from a bulk supply of the product. In some embodiments, the filling step may be performed or conducted by a third party.

After cleaning and sanitization, the containers 30, 40 may be organized and grouped into one or more batches, with each batch being assigned a batch code (i.e., a primary container batch code or a shipping container batch code) which comprises identifying information about a corresponding batch of containers 30, 40. A record of each batch is created during which each batch code is associated with a corresponding batch of containers 30, 40. Additionally, the record of each container 30, 40 is updated to associate each container 30, 40 with a corresponding batch.

With particular reference to shipping containers 40, a sanitized batch of shipping containers 40 may be assigned a shipping container batch code, which may be entered into the warehouse management system (e.g., by mobile device 52), and counted. The sanitized batch of shipping containers 40 is automatically added to the fulfillment inventory (via the shipping container batch code) and designated as ready-to-use via the warehouse management system. At this point, shipping containers are ready to be used for order fulfillment.

With particular reference to primary containers 30, and referring to Step 105, in preparation for filling, primary containers 30 may be organized into a batch. Following, and with reference to Step 106, a batch code is assigned to the batch of primary containers 30. A record of the batch is then created and, as referenced in Step 107, each record of the primary containers 30 is updated to associate primary containers 30 with the batch (and, therefore, the batch code). At this point, primary containers 30 are ready to be filled with the defined amount of product 20 from the bulk supply of the product. The specific bulk supply of the product with which primary containers 30 are to be filled may be determined by the corresponding primary container batch code and such information may be associated with the corresponding records of primary containers 30.

Following Step 107, and in accordance with Step 108, primary containers 30 are filled with the defined amount of the product 20 from the bulk supply of the product (according to their corresponding primary container batch code). Filling of the primary container(s) 30 with the defined amount of product 20 may be performed on-site or at a separate location (e.g., filled by a third party). Once primary containers 30 have been filled with the defined amount of product 20 (and returned by the third party filler, if applicable), the record of each primary container 30 may be updated to reflect that the primary container(s) 30 are ready to be used for order fulfillment.

Following Step 108, and with reference to Step 109, one or more primary containers 30 and shipping containers 40 may be determined or selected to fulfill an order. Then, with reference to Step 110, when an order for a product is being fulfilled, the record of the determined or selected primary container(s) 30 is updated to associate the selected primary container(s) 30 with the order. Similarly, during order fulfillment, the record of the determined or selected shipping container(s) 40 is updated to associate the selected shipping container(s) 40 with the order. Furthermore, if it has been indicated at the time that the order was placed that one or more used primary containers 30 are to be returned (e.g., as requested by the customer), the record of the used primary container(s) 30 may also be updated to be associate the used primary container(s) 30 with the order.

Following Step 110, the selected primary container(s) 30 are placed into the selected shipping container(s) 40. Then, with reference to Step 112, once the order has been fulfilled, a shipment of the primary container(s) 30 and shipping container(s) 40 to a recipient (e.g., a customer) is coordinated, in which the primary container(s) 30 (containing the defined amount of product 20) are stored in the shipping container(s) 40 during transit thereof. With reference to Step 113, following receipt by the recipient or customer, the recipient or customer may then coordinate the return of the shipping container(s) 40 with the used primary container(s) 30 associated with the order, after which the used container(s) 30, 40 may be received back at the warehouse.

Following Step 113, and with reference to Step 114, upon return (e.g., to a warehouse or order fulfillment center) of the used shipping container(s) 40 and the used primary container(s) 30 by the recipient or customer, the records of the used shipping container(s) 40 and the used primary container(s) 30 may be updated to dissociate the containers 30, 40 from the order. It is to be understood that, in some cases, a customer, for example, may not have any primary container(s) 30 to return, in which case, the customer may only return the shipping container(s) 40.

When a used primary container 30 or used shipping container 40 is returned undamaged, process flow 100 may return to Step 104 and continue in a circular manner (i.e., Steps 104-110 are repeated). More particularly, returned used containers 30, 40 are subjected to Step 104, during which they are once again prepared and sanitized for order fulfillment, followed by the processes of Steps 105-114. If a used primary container 30 or used shipping container 40 is returned damaged, then Step 110 may be followed by Steps 115A or 115B, depending on the severity of the damage. For example, and with reference to Step 115A, if the extent of the damage to the container 30, 40 is such that the container 30, 40 can be repaired, it will be taken out of the available inventory and repaired. Once repaired, the container 30, 40 will be reintroduced into the cycle of Steps 104-114. If, for example, and with reference to Step 115B, the extent of the damage is such that the container 30, 40 cannot be repaired, it may be taken out of the available inventory and retired (preferably recycled).

It is to be understood that during any point of the lifecycle of a container 30, 40, the container 30, 40 may be taken out of the cycle of Steps 104-114. For example, if a previously sanitized container 30, 40 becomes contaminated at any point prior to being shipped, the container 30, 40 may undergo re-sanitization (i.e., process flow 100 may revert to Step 104), after which the container 30, 40 may be subjected all subsequent steps which occurred between the previous sanitization and the point of contamination. In any event, the record of a container 30, 40 may be updated to reflect its current status (e.g., contaminated, damaged and repairable, damaged and unrepairable, etc.).

Further to the above, it is also to be understood that a container code (i.e., the primary container code 34 or the shipping container code 44) may be scanned at various points throughout a container's lifecycle and reuse cycle. For example, a container code 34, 44 may be scanned at the following points: (i) upon initial intake during which a container 30, 40 is assigned a container code 34, 44 which is scanned to introduce the container 30, 40 into to the system; (ii) upon receipt of a used container 30, 40 during which the container code 34, 44 is scanned and the container 30, 40 is recorded as being received from a customer; (iii) after sanitization (for primary containers 30, before filling) during which a plurality of container codes 34, 44 are scanned and the corresponding containers 30, 40 are combined into a batch (either to be filled with the defined amount of product from the bulk supply of the product or to be used for order fulfillment); (iv) upon arrival of a batch of containers 30, 40 during which container codes 34, 44 are scanned and the corresponding containers 30, 40 are indicated as being received in the system 10 (any missing, damaged, or contaminated primary containers 30 are recorded accordingly in the system 10); (v) when a container 30, 40 is selected to fulfill a customer order during which the container code 34, 44 is scanned and associated with the order; and (vi) before re-sanitization, prior to which the container code 34, 44 of a contaminated container 30, 40 (which can occur at any point) is scanned and the contaminated container 30, 40 is recorded accordingly in the system 10. At various points, a container 30, 40 may also be selected for quality testing and monitoring which may cause the container code 34, 44 to be scanned prior to, and after, quality testing and monitoring.

According to some embodiments of the present invention, provided are methods by which a customer may purchase a defined amount of product (e.g., filled from a bulk supply of the product), while renting the containers (i.e., primary containers 30 and shipping containers 40) in which the defined amount of product 20 is contained during use and transport, and then return the containers 30, 40 once they are no longer needed.

A customer may directly place an order for a defined amount of the product 20 via a website or a mobile application (e.g., an application downloaded and executed on a smartphone). According to some embodiments, orders may be placed on a one-time or auto-replenishment (e.g., subscription-based) basis. For the latter case, a customer may be able to select a desired frequency and timing (day and/or time) of order deliveries. A customer may also be able to create an account, which may allow the customer to more easily place, manage, and track orders.

For an initial purchase, a customer may purchase the defined amount of product 20, rent a primary container 30 for containing the defined amount of the product 20, and rent a shipping container 40 for containing the filled or finished product (i.e., the primary container 30 filled with the defined amount of the product 20) during transport thereof. Upon receipt, the customer may remove the finished product from the shipping container 40 and then return the shipping container (e.g., to a warehouse). For a subsequent purchase, the customer may purchase a defined amount of a product 20 (which may be the same as, or different from, the defined amount of product 20 purchased in the initial order) and rent a primary container 30 and a shipping container 40. At the time of purchase, the customer may also indicate that the primary container 30 from the initial order needs to be returned. Upon receipt, the customer may remove the finished product from the shipping container 40, place the (now empty) primary container 30 from the initial order in the shipping container 40, and then return the shipping container 40 and included empty primary container 30. It is to be understood that, for subsequent orders, a customer may not always have a primary container 30 to return (e.g., the customer places another order, but has not finished using the product from an earlier order), in which case the customer would only return the shipping container 40 (similar to the procedure of the initial order).

When a customer places an order for a defined amount of product 20, the operational control system 50 selects or determines the size and/or quantity of primary containers 30 needed to hold the defined amount of product 20. System 10 may also select or determine the size and/or quantity of the shipping container 40 needed to hold the selected size and/or quantity of primary containers 30 during transport. The system 10 then determines a container rental fee based at least on the selected primary container(s) 30 and the selected shipping container 40. The payment card used to place the order is then charged for the purchase of defined amount of the product 20. The payment card may also be charged an amount equal to the determined rental fee for the primary container(s) 30 and shipping container(s) 40. In other embodiments, a hold may be placed on the customer's payment card in an amount equal to the determined rental fee. In still other embodiments, a portion of the determined rental fee may be charged to the customer with the balance of the determined rental fee being subject to a hold. The payment card may also be charged for any other applicable fees, such as shipping costs. Shipping costs may be calculated by an application programming interface (“API”) integrated with the operational control system which, for example, may be determined by the weight and/or size of the filled shipping containers, as well as the destination of the order. One or more APIs integrated with the operational control system may also provide information related to the order transit, such as, but not limited to, a transit status, an estimated day and/or time of delivery, and a delivery status.

As previously described, the operational control system may automatically determine the quantity and size of primary container(s) 30 and shipping container(s) 40 needed to fulfill an order for a defined amount of the product 20. More particularly, and in accordance with some embodiments, the number of large and small slots (e.g., large slots 41 and small slots 42, illustrated in FIG. 3) needed to store finished products ordered by a customer, as well as the primary containers 30 that the customer is planning to return (which the customer indicates during order placement) may be automatically determined.

When a customer places an order for a defined amount of the product 20, the customer may select the used primary container(s) 30 he or she is planning to return in the shipping container 40 that will be sent to the customer. By taking into account the quantity and size of the primary containers 30 the customer wants to return, as well as the quantity and size(s) of the primary container(s) 30 the customer is renting (which contain finished products), an algorithm embedded in software automatically determines the optimum size and quantity of shipping containers 40 needed to transport the ordered finished product to the customer, as well as to transport any primary containers 30 being returned by the customer.

In some embodiments, each shipping container slot 41, 42 can contain a total proxy volume value of 10, and each primary container 30 may have a proxy volume value between 1 and 10 and may be configured to fit in a large slot 41 or small slot 42 without additional packing material. The algorithm takes into account the slot width(s) of the shipping container 40, the volume of the filled primary containers 30 of the order, and the empty (used) primary containers 30 being returned to automatically designate either a small or large shipping container 40, or any combination thereof, as the case may be.

According to some embodiments, proxy volume values may be assigned according to Table 1, below. However, the present invention should not be viewed as being limited in this respect as various other proxy values could also be used.

TABLE 1

| | Shipping Container | |
|---|---|---|
| Primary Container Type | Slot Size | Volume |
| Extra Large Jar | Wide | 10 |
| Large Jar | Wide | 8 |
| Medium Jar | Wide | 6 |
| Small Jar | Wide | 4 |
| Serum Bottle | Narrow | 5 |
| Sample Jar | Narrow | 2 |

At the time that the customer places the order, one or more holds (e.g., security deposit) may also be placed on the customer's payment card for a given amount. The amount held may be equal to a non-return fee which may be captured in the event that a container (i.e., a primary container and/or shipping container) is not returned, returned late, or returned damaged. If a customer has multiple outstanding rented containers (i.e., primary containers 30 and/or shipping containers 40 that are in the custody of the customer) and the customer returns less than all of the outstanding rented containers 30, 40, only the corresponding holds may be cancelled, or the hold may be reduced by an appropriate amount equal to the non-return fee(s) of the returned containers 30, 40. If a customer fails to return a container 30, 40 within a given timeframe or the container 30, 40 is returned damaged, the hold amount, or a portion thereof, will be charged to the customer's payment card. If a customer returns one or more of its outstanding rented containers 30, 40, but also fails to return one more or more of its outstanding rented containers 30, 40 within a given amount of time (or returns any damaged containers), only the hold(s) corresponding to the returned containers 30, 40 (or those returned on time) will be cancelled and the hold(s) corresponding to the non-returned containers 30, 40 will be charged to the customer's payment card. If a single hold was placed for multiple rented containers 30, 40, the hold amount would be reduced by the total amount of the non-return fees of the returned containers 30, 40 and the customer's payment card would be charged for the total amount of the non-return fee(s) of the non-returned containers.

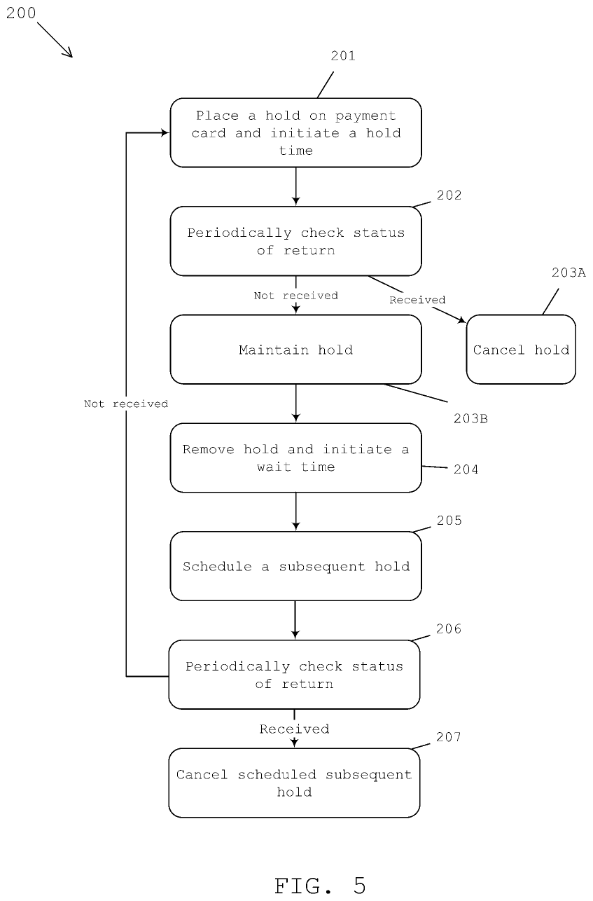

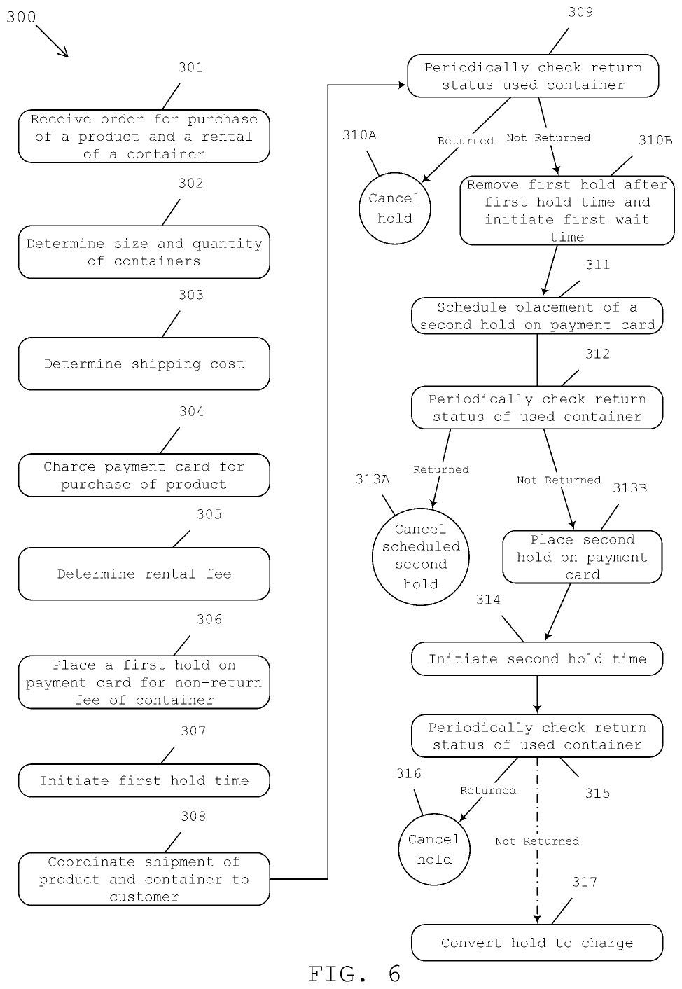

Payment card processing methods disclosed herein allow for a customer to keep primary containers 30 for a first predetermined time (e.g., six months) and shipping containers 40 for a second predetermined time (e.g., one month) while allowing the continuous and automatic placement of holds on a customer's payment card without having two holds active at the same time. Wait periods are initiated between holds to ensure that any previous hold is removed from a payment card before placing a subsequent hold to verify that there is no overlapping holds. This may be achieved, generally, by a cyclical process 200, illustrated in FIG. 5, involving: placing a hold on a payment card for the rental of one or more containers 30, 40 for a given, predetermined hold time, as referenced in Step 201; periodically checking (e.g., checking at pre-determined, regular time intervals) a status of return (i.e., returned or not returned) of the rented container(s) 30, 40 during the hold time, as referenced in Step 202, and either (i) cancelling the hold, if the rented container(s) 30, 40 is (are) returned, as referenced in Step 203A, or (ii) maintaining the hold, if the rented container(s) 30, 40 is (are) not returned upon expiration of the hold time, as reference in Step 203B; if the hold is maintained, removing the hold upon expiration of the hold time and initiating a predetermined wait time, as referenced in Step 204; scheduling a subsequent hold to be placed upon expiration of the wait time, as referenced in Step 205; during the wait time, periodically checking a status of return of the rented container(s) 30, 40 during the wait time, as referenced in Step 206, and cancelling the scheduled subsequent hold, if the rented container(s) 30, 40 is (are) returned, as referenced in Step 207; if the rented container(s) 30, 40 is (are) not returned, placing the subsequent hold upon expiration of the wait time, as referenced in Step 201 (i.e., process 200 reverts to Step 201 and continues accordingly). This pattern of steps continues until the rented container(s) 30, 40 is (are) returned, or until a given amount of time to return the rented container(s) 30, 40 has elapsed.

An exemplary implementation of a payment card and order processing method 300, which incorporates aspects of process 200 described above, is illustrated in FIG. 6. Starting with Step 301, an order is received from a customer (by, for example, operational control system 50) for the purchase of a defined amount of product and a rental of a container 30, 40. Following, and with reference to Step 302, a size and quantity of rented container 30, 40 is determined (e.g., by operational control system 50). Next, and with reference to Step 303, a shipping cost is determined, wherein the shipping cost may be based on the weight of the defined amount of product 20 and rented container 30, 40. Following, and with reference to Step 304, the payment card associated with the order is charged for the purchase of the defined amount of the product 20. Then, as referenced in Step 305, a rental fee is determined, wherein the rental fee may be based on the rented container 30, 40. Then, and with reference to Step 306, a first hold is placed on the payment card for the amount of a non-return fee, which may be charged in the event of the non-return or late return of the rented container 30, 40. Following Step 306, and with reference to Step 307, a first hold time is initiated, where the first hold is set to expire upon expiration of the first hold time. Next, and with reference to Step 308, a shipment of the purchased defined amount of product 20 and rented container 30, 40 from a warehouse to the customer is coordinated. Thereafter, and with reference to Step 309, a status of return, by the warehouse from the customer, of the rented container 30, 40 is checked on a periodic basis throughout the duration of the first hold time. If the rented container 30, 40 is returned at any time within the period of the first hold time (as recorded, for example, within operational control system 50), the first hold is cancelled, as referenced in Step 310A. However, and with reference to Step 310B, if the rented container 30, 40 is not returned by the time that the first hold time expires, the first hold is removed and a first wait time is initiated.

Following Step 310B, and with reference to Step 311, a second hold is scheduled to be placed on the payment card (e.g., for the same amount as the first hold) after the expiration of the first wait time. Then, and as referenced in Step 312, the return status of the rented container 30, 40 is checked on a periodic basis throughout the duration of the first wait time. If the rented container 30, 40 is returned at any time within the period of the first wait time, the scheduled placement of the second hold is cancelled, as referenced in Step 313A. However, and with reference to Step 313B, if the rented container 30, 40 is not returned by the time that the first wait time expires, the second hold is placed on the payment card upon expiration of the first wait time.

Following Step 313B, and with reference to Step 314, a second hold time is initiated, where the second hold is set to expire after the expiration of the second hold time. Then, and as referenced in Step 315, the return status of the rented container 30, 40 is checked on a periodic basis throughout the duration of the second hold time. If the rented container 30, 40 is returned at any time within the period of the second hold time, the second hold is cancelled, as referenced in Step 316. However, if the rented container is not returned by the time that the second hold expires, the pattern of placing and scheduling holds, initiating wait times, and periodically checking the return status of the rented container 30, 40 continues as described. This pattern then continues until the rented container 30, 40 is returned, or until a given amount of time to return the rented container 30, 40 has elapsed (denoted by the dashed arrow). At this point, and with reference to Step 317, any outstanding hold is converted to charge on the payment card for the amount of the non-return fee. Alternatively, in some embodiments, a late fee may be charged if the rented container 30, 40 is returned late.

In some embodiments, the credit card processing system of the operational control system may register the wait times and hold times and automatically check these fields on a regular basis (using, for example, a scheduler) to ensure the holds are placed in a timely manner. As previously described, a hold time and a wait time may each comprise pre-determined time intervals. After a first hold time has expired, any subsequent hold times may increase, decrease, or stay the same as the first hold time. Likewise, after a first wait time has expired, any subsequent wait times may increase, decrease, or stay the same as the first wait time. For example, a first wait time may expire after one day, a second wait time may expire after seven days, a third wait time may expire after 14 days, and a fourth wait time may expire after 30 days. In another example, a first hold, a second hold, a third hold, and a fourth hold may all expire after seven days. It is to be appreciated, however, that the hold times or wait times may be any given length of time and may vary relative to any preceding or subsequent hold times or wait times by any given amount of time. It is also to be appreciated that a first series of hold times or wait times may increase (or decrease, or remain the same) with each successive hold time or wait time, whereas a second series of hold times or wait times may remain the same (or decrease, or increase) with each successive hold time or wait time. For example, a first hold time, a second hold time, and a third hold time may increase with each successive hold time, whereas a fourth hold time, a fifth hold time, and a sixth hold time may remain the same with each successive hold time.

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, and/or steps. The foregoing also applies to words having similar meanings such as the terms, “including,” “having” and their derivatives. Any terms of degree such as “substantially,” “about” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adapted to another embodiment. It should be noted that while the present invention is shown and described herein as it could be used in conjunction with a configuration of various components, it could be utilized with other configurations, either now known in the art or that may be developed in the future, so long as the objects and features of the invention are achieved, as would become apparent to persons having ordinary skill in the art after having become familiar with the teachings provided herein. Consequently, the present invention should not be regarded as limited to that shown and described herein. It is not necessary for all advantages to be present in a particular embodiment at the same time. Thus, the foregoing descriptions of the embodiments according to the present invention are provided for illustration only, and not for the purpose of limiting the invention as defined by the appended claims and their equivalents.

Having herein set forth preferred embodiments of the present invention, it is anticipated that suitable modifications can be made thereto which will nonetheless remain within the scope of the invention, including all changes that come within the meaning and range of equivalents. The invention shall therefore only be construed in accordance with the following claims.

1. A method of fulfilling an order for a product placed by a customer, comprising:
receiving from the customer an order for a defined amount of the product;
selecting a primary container, the primary container being adapted to hold the defined amount of the product;
selecting a shipping container, the shipping container being adapted to hold the selected primary container;
determining a shipping cost for shipping the shipping container to a location provided by the customer;
charging a product and shipping fee to an account associated with the customer, the product and shipping fee based at least on the amount of defined product ordered and the shipping cost;
determining a container rental fee based at least on the selected primary container and the selected shipping container;
placing a hold on the account associated with the customer for an amount equal to the container rental fee;
filling the selected primary container with the defined amount of the product from a bulk supply of the product;
placing the filled selected primary container in the selected shipping container; and
shipping the selected shipping container to the location identified by the customer.

2. The method of claim 1, further comprising:
receiving a returned shipping container from the customer; and
removing at least a portion of the hold placed on the account associated with the customer.

3. The method of claim 1, wherein the receiving the returned shipping container from the customer further comprises receiving a returned shipping container and a returned primary container from the customer.

4. The method of claim 3, further comprising:
sanitizing the returned shipping container; and
sanitizing the returned primary container.

5. The method of claim 1, further comprising converting the hold placed on the account associated with the customer to a charge on the account associated with the customer for the container rental fee after a defined period of time and when no returned shipping container is received.

6. An order fulfillment system, comprising:
a plurality of primary containers configured to contain a product therein, wherein each of the primary containers comprises a corresponding primary container code and wherein each primary container code comprises identifying information about a corresponding one of the primary containers;
a plurality of shipping containers for storing the primary containers during transport thereof, wherein each of the shipping containers comprises a corresponding shipping container code and wherein each shipping container code comprises identifying information about a corresponding one of the shipping containers;
an operational control system comprising (i) a server comprising a memory having a database and (ii) at least one mobile device operatively connected to the server and configured to detect the primary container code and the shipping container code, wherein the operational control system is configured to:
create and update an electronic record, in the database, of each of the primary containers, wherein the electronic record comprises information associated with the primary container code;
create and update an electronic record, in the database, of each of the shipping containers, wherein the electronic record comprises information associated with the shipping container code;
receive an order for a product and create an electronic record, in the database, of the order;
determine a size and a quantity of the primary containers, wherein the size and the quantity of the primary containers are determined based on the electronic record of the order;
determine a size and a quantity of the shipping containers, wherein the size and the quantity of the shipping containers are determined based on the size and the quantity of the primary containers;
process the order, the order comprising a purchase of the product, a rental of the quantity of the primary containers, and a rental of the quantity of the shipping containers;
update the electronic record of the order to associate the electronic record of the order with a first one of the primary containers and a first one of the shipping containers, wherein the first one of the primary containers contains the product;
provide instructions to place the first one of the primary containers in the first one of the shipping containers; and
provide instructions to ship the first one of the shipping containers.

7. The system of claim 6, wherein the operational control system is further configured to provide instructions to return the first one of the shipping containers.

8. The system of claim 7, wherein the operational control system is further configured to update the electronic record of the first one of the shipping containers to dissociate the first one of the shipping containers with the electronic record of the order.

9. The system of claim 6, wherein the operational control system is further configured to process a payment card associated with the order.

10. The system of claim 7, wherein the operational control system further comprises a sanitization system operatively connected to the server.

11. The system of claim 10, wherein the operational control system is further configured to provide instructions to sanitize the first one of the shipping containers using the sanitization system.

12. A method for managing and tracking reusable containers, comprising the steps of:
receiving a plurality of unused containers;
permanently affixing a container code to each of the unused containers, wherein each container code comprises identifying information about a corresponding one of the unused containers;
creating a record of each of the unused containers, wherein each container code is associated with a corresponding record;
preparing the unused containers, comprising sanitizing the unused containers;
updating the record of at least one of the unused containers to associate the at least one of the unused containers with a first order;
updating a record of at least one of a plurality of used containers to associate the at least one of the used containers with the first order, wherein each of the used containers comprises a container code comprising identifying information about a corresponding one of the used containers;
coordinating a shipment of the at least one of the unused containers to a recipient;
receiving from the recipient the at least one of the used containers; and
updating the record of the at least one of the used containers.

13. The method of claim 12, wherein the step of preparing the unused containers further comprises:
assigning a container batch code to a first one of the unused containers;
updating the record of the first one of the unused containers to associate the container batch code with the record of the first one of the unused containers; and
filling the first one of the unused containers with a product;
wherein the at least one of the unused containers comprises the first one of the unused containers.

14. The method of claim 13,
wherein the first one of the unused containers is a first primary container,
wherein a second one of the unused containers is a first shipping container, and
wherein the at least one of the unused containers further comprises the second one of the unused containers.

15. The method of claim 14, wherein the first primary container is stored within the first shipping container.

16. The method of claim 14, wherein the at least one used container comprises the first shipping container and wherein the step of updating the record of the first shipping container comprises dissociating the first shipping container with the first order.

17. The method of claim 16, wherein the at least one used container further comprises a second primary container and wherein the step of updating the record of the second primary container comprises dissociating the second primary container with the first order.

18. The method of claim 14, wherein the at least one used container comprises a second shipping container and wherein the step of updating the record of the second shipping container comprises dissociating the second shipping container with a second order.

19. The method of claim 18, wherein the at least one used container further comprises the first primary container and wherein the step of updating the record of the first primary container comprises dissociating the first primary container with the second order.

20. The method of claim 12, wherein the step of updating the record of the at least one of the used containers comprises updating a status of the at least one of the used containers.

21. The method of claim 20, further comprising the step of:
if the status of the at least one of the used containers is damaged, repairing the at least one of the used containers.

22. The method of claim 20, further comprising the step of:
if the status of the at least one of the used containers is damaged, recycling the at least one of the used containers.

23. The method of claim 22, further comprising the step of:
eliminating the record of the at least one of the used containers.

24. A method for managing the rental of a container using an operational control system comprising a payment processing system comprising a server operatively connected to a network, wherein the server is configured to facilitate payment card transactions, the method comprising the steps of:
receiving an order, wherein the order comprises a purchase of a product and a rental of a container for containing the product;
charging a payment card for the purchase of the product;
placing a first hold on the payment card for the container;
initiating a first hold time, wherein the first hold expires after the first hold time;
coordinating a shipment of the product and the container from a warehouse to a customer;
periodically checking a status of return of the container by the warehouse from the customer during the first hold time and, if the container is not returned, maintaining the first hold;
after the expiration of the first hold time, removing the first hold and initiating a first wait time;
scheduling the placement of a second hold on the payment card;
periodically checking a status of receipt of the container by the warehouse from the customer during the first wait time;
after the expiration of the first wait time and if the container is not returned, placing the second hold on the payment card;
initiating a second hold time, wherein the second hold expires after the second hold time; and
periodically checking a status of return of the container by the warehouse from the customer during the second hold time and, if the container is not received, maintaining the second hold.

25. The method of claim 24, further comprising the steps of:
after the expiration of the second hold time, removing the second hold and initiating a second wait time;
scheduling the placement of a third hold on the payment card; and
periodically checking a status of return of the container by the warehouse from the customer during the second wait time.

26. The method of claim 25, wherein the first hold time is the same as the first hold time.

27. The method of claim 26, wherein the second wait time is greater than the first wait time.

28. The method of claim 24, wherein the first hold is for a first transaction amount and wherein the second hold is for a second transaction amount.

29. The method of claim 24, further comprising the step of:
converting the second hold to a charge and charging the payment card for the second transaction.
